(19) United States
(12) Patent Application Publication
(10) Pub. No.: US 2024/0207897 A1
(43) Pub. Date: Jun. 27, 2024

(54) PROTECTIVE PLATE FOR A VIBRATORY SCREEN

(71) Applicant: MIS. CARBONART PTY LTD (A SUBSIDIARY OF MINERAL RESOURCES LIMITED), Osborne Park, Western Australia (AU)

(72) Inventor: Philip BARNES, London (GB)

(21) Appl. No.: 18/683,881

(22) PCT Filed: Aug. 18, 2022
(86) PCT No.: PCT/AU22/50918

§ 371 Date: Feb. 15, 2024

(30) Foreign Application Priority Data
Aug. 18, 2021 (AU) 2021902577

(51) Int. Cl. B07B 1/46; B07B 1/28

(52) U.S. Cl. CPC B07B 1/46; B07B 1/28

(57) ABSTRACT

The invention provides a protective plate (200) for a vibratory screen (100) having a side panel (170) and a screen deck (120). The protective plate (200) comprises an outer surface (210) for connecting the protective plate to the side panel (170) and an inner surface (220) for protecting the side panel. The inner surface (220) has one or more connecting elements (230) for connecting the protective plate (200) to the screen deck (120).

### FIELD OF THE INVENTION

The invention relates to a protective plate and in a particular to a protective plate for a vibratory screen. The invention has been developed primarily for use as a protection system for a vibratory screen applied to the separation of mineral ore and will be described hereinafter by reference to this application. However, it will be appreciated that the invention is capable of other applications, such as the protection of screening apparatus used in separating corrosive or crushable materials or suspensions.

### BACKGROUND OF THE INVENTION

The following discussion of the prior art is intended to present the invention in an appropriate technical context and allow its advantages to be properly appreciated. Unless clearly indicated to the contrary, however, reference to any prior art in this specification should not be construed as an express or implied admission that such art is widely known or forms part of common general knowledge in the field.

Vibratory screens are frequently used in the mining and mineral processing industries for separating ores of different particle sizes. Vibratory screens can be used in variety of applications. For example, in the separation of dry particles, such as iron ore. In another example, vibratory screens are used in the separation of wet particles from dry particles, such as that used in spodumene separation (spodumene being the hard rock precursor to lithium hydroxide or lithium carbonate).

A typical vibratory screen comprises a frame mounted on springs with a screen or deck fitted to the frame and a drive mechanism to induce vibrations in the frame (and hence, the screen). Generally, vibratory screens are either designated as inclined or horizontal, referring to the type of motion used. A horizontal vibratory screen uses a reciprocating or back and forth motion to induce vibrations, whereas an inclined vibratory screen uses a circular motion to induce vibrations. The drive mechanism has a motor operably connected to one or more drive members, beams or shafts mounted to the frame. The motor induces movement to the drive beam(s), which is transmitted to the frame and generates vibrations. The drive beam(s) may have eccentric weights to assist in generating vibrations. In operation, mineral ore having a variety of particle sizes is loaded onto the screen or deck. Vibrations are generated by the drive mechanism and transmitted to the frame and screen, causing the ore particles to be classified according to the size of the holes in the screen.

The main deficiencies in current vibratory screens revolve around longevity, especially when the vibratory screen is used as solid separation screens in a liquid separation/dewatering process, which has an increased tendency to create pitting and corrosion. Conventional vibratory screens are made entirely of a mixture of steel, stainless steel and polyurethane, depending on the component. As such, conventional vibratory screens tend to break easily, be damaged by impact strikes from moving ore particles, corrode, bend, rust or otherwise degrade, especially when the ore material is corrosive and/or abrasive, or the liquid operating environment promotes corrosion or rust in the vibratory screen components. This results in conventional vibratory screens requiring frequent refurbishment or replacement. For example, refurbishment may be required every 6 to 8 months when used in a dewatering/wet process. Refurbishment typically costs around AUD100,000. Hence, the need for constant refurbishment due to corrosion and fatigue imposes a significant capital, operational and maintenance burden.

To partly address these problems, some current vibratory screens employ a protection system to resist corrosion and impact damage by mounting protection plates, often constructed of polyurethane and the like, mounted to the sides of the frame adjacent to the screen or deck. These side protection plates are friction fitted to the vibratory screen by wedging the plates into place between the screen deck and side panel using a wedge and sledge hammer. However, this installation method makes the protection plates difficult to replace, requiring significant labour and thus increased downtime of the vibratory screen.

It is an object of the present invention to overcome or substantially ameliorate one or more of the disadvantages of prior art, or at least to provide a useful alternative. It is an object of the invention in at least one preferred form to provide an improved or useful alternative side protection plate for the vibratory screen.

### SUMMARY OF THE INVENTION

A first aspect of the invention provides a protective plate for a vibratory screen having a side panel and a screen deck, comprising:
an outer surface for connecting the protective plate to the side panel; and
an inner surface for protecting the side panel;
wherein the inner surface has one or more connecting elements for connecting the protective plate to the screen deck.

In some embodiments, the connecting elements are configured to connect the protective plate to the screen deck.

In some embodiments, the connecting elements comprise flanges for cooperating with one or more corresponding connecting elements of the screen deck. In one embodiment, the flanges each have two or more arms for engaging the screen deck. In another embodiment, the flanges are substantially U-shaped or substantially C-shaped. In further embodiments, the flanges are substantially V-shaped, U-shaped, hexagonal, oval, triangular, rectangular, octagonal, decagonal, dodecagonal or any other polygonal or part polygonal shape. In other embodiments, the connecting elements have a shape substantially complementary to the corresponding connecting elements of the screen deck.

In other embodiments, the connecting elements comprise at least one of a protrusion, tooth, lug or prong for cooperating with a corresponding connecting element of the screen deck. In further embodiments, the connecting elements comprise a slot, sleeve or opening for cooperating with a corresponding connecting element of the screen deck.

In some embodiments, the inner surface comprises one or more protrusions or covers for protecting the connecting elements. In other embodiments, the one or more protrusions or covers are configured to protect the connecting elements. In further embodiments, at least one protrusion comprises one or more ridges extending along or adjacent the inner surface. In further embodiments, the one or more ridges extend along or adjacent the length of the inner surface of the protective plate. In one embodiment, the ridges are aligned. In another embodiment, two or more ridges are offset from each other. In yet another embodiment, the ridges arranged between the connecting elements of the protective plate. In yet further embodiments, the protrusions may be teeth or studs.

In some embodiments, the screen deck comprises a screen surface supported by one or more rails, wherein at least one rail cooperates with the connecting elements. In other embodiments, the at least one rail comprises one or more connecting elements for engaging the connecting elements of the protective plate. In further embodiments, at least one connecting element of the at least one rail comprises a collar. In additional embodiments, the at least one connecting element of the at least one rail comprises an annular flange or ring.

In some embodiments, the at least one rail and the connecting elements of the protective plate are connected by a fastener. In other embodiments, the connecting elements of the protective plate and the screen deck are connected by the fastener. In further embodiments, the fastener comprises a bolt, pin or rod.

In some embodiments, the screen surface comprises connecting elements for connecting the screen deck to the protective plate. In other embodiments, the connecting elements of the screen surface comprises a bolt, pin or rod.

In some embodiments, the outer surface comprises one or more protrusions for engaging the side panel. In other embodiments, at least one protrusion comprises a ridge extending along the outer surface. In further embodiments, the ridge extends along the length of the outer surface of the protective plate. In additional embodiments, there are multiple ridges. In one embodiment, the ridges are aligned. In another embodiment, two or more ridges are offset from each other. In yet further embodiments, the protrusions may be teeth or studs. In some embodiments, the outer surface comprises a resilient member to tension the protective plate and/or absorb forces applied to the outer surface.

A second aspect of the invention provides a vibratory screen, comprising:
a frame having side panels;
at least one screen deck; and
one or more protective plates according to the first aspect of the invention mounted to at least one side panel.

This second aspect of the present invention may have the features of the embodiments of the first aspect above.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Furthermore, as used herein and unless otherwise specified, the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### BRIEF DESCRIPTION OF THE DRAWINGS

Preferred embodiments of the invention will now be described, by way of example only, with reference to the accompanying drawings in which:

FIG. 1 is a perspective view of a vibratory screen with a protective plate according to an embodiment of the invention;

FIG. 2 is another perspective view of the vibratory screen shown in FIG. 1;

FIG. 3 is a partial perspective view of the side panel of the vibratory screen shown in FIGS. 1 and 2;

FIG. 4 is a partial perspective view of the protective plate shown in FIG. 3;

FIG. 5 is a rear perspective view of the protective plate shown in FIG. 3;

FIG. 6 is a partial lower perspective view of the protective plate shown in FIG. 3;

FIG. 7 is a partial close up perspective view of the protective plate shown in FIG. 3; and

FIG. 8 is a partial close up perspective view of the protective plate shown in FIG. 3 fitted to the side panel and screen deck shown in FIGS. 1 and 2; and

FIG. 9 is another partial close up perspective view of the protective plate shown in FIG. 3 fitted to the side panel and screen deck shown in FIGS. 1 and 2.

### PREFERRED EMBODIMENTS OF THE INVENTION

The present invention will now be described with reference to the following examples which should be considered in all respects as illustrative and non-restrictive. In the Figures, corresponding features within the same embodiment or common to different embodiments have been given the same reference numerals.

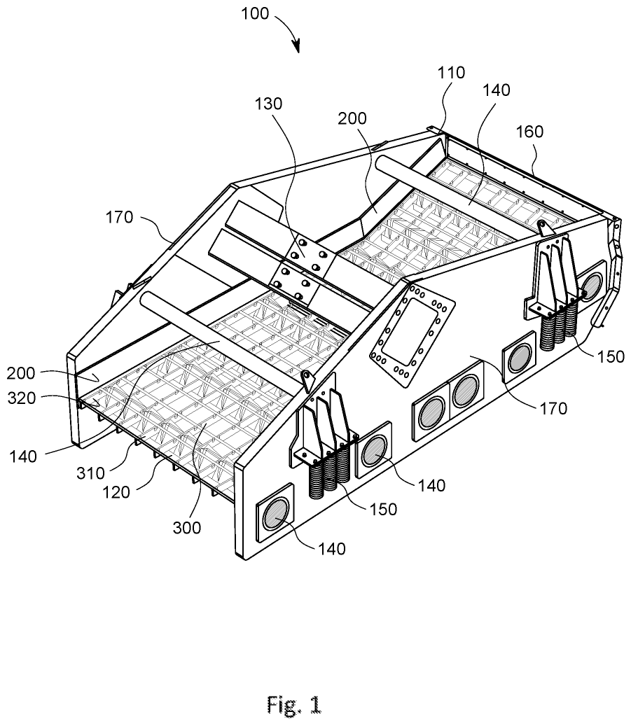

Referring to FIGS. 1 to 3, a vibratory screen 100 has a frame 110, a screen deck 120, drive member assembly 130, supporting cross beams 140 and springs 150. The frame 110 has a back or rear panel 160 and two side panels 170. The screen deck 120 is connected to the rear panel 160 and side panels 170 of the frame 110.

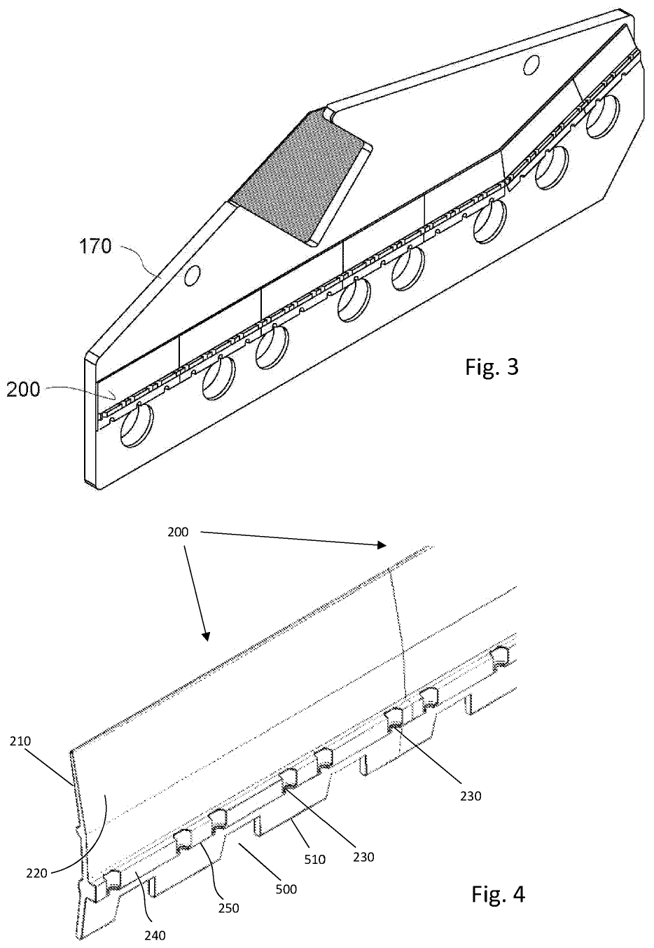

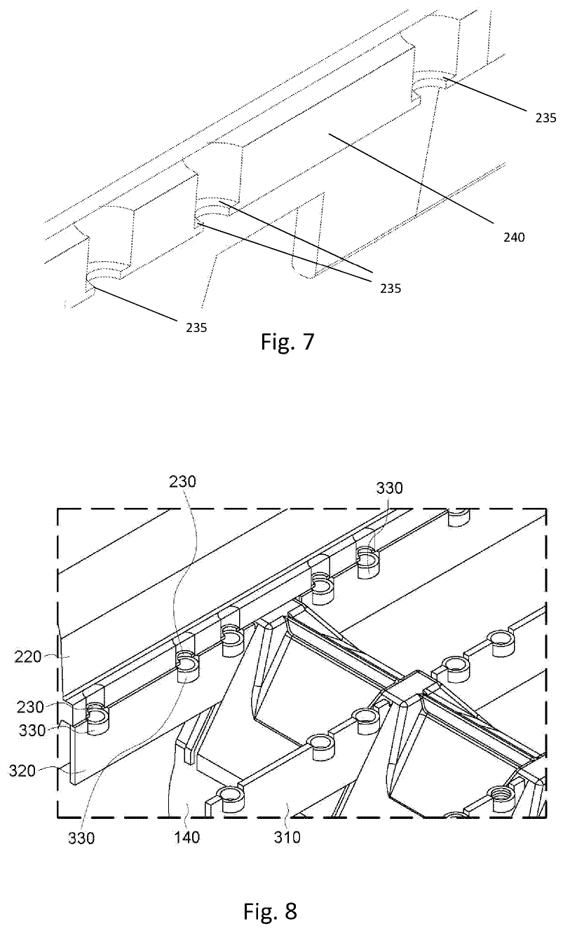

The side panels 170 each have several protective plates 200 according to one embodiment of the invention, as best shown in FIGS. 3 to 7. Each protective plate 200 is composed of polyurethane and has an outer surface 210 for connecting the protective plate to the side panels 170 and an inner surface 220 for protecting the side panel. The inner surface 220 protects the side panels 170 from damage caused by impact strikes, abrasion and/or corrosion from the ore particles during operation of the vibratory screen 100.

The inner surface 220 also has a plurality of connecting elements for connecting the protective plate 200 to the screen deck 120. In this embodiment, the connecting elements take the form of U-shaped or C-shaped flanges 230 for cooperating with a corresponding connecting element of the screen deck 120, as best shown in FIGS. 4 and 6. The flanges 230 are located at several points along a protrusion in the form of a ridge 240 at its lower edge 250. As shown in FIGS. 6 to 8, the flanges 230 each have two arms 235 for engaging the screen deck 120. Generally, the number of flanges 230 equal the number of fasteners (such as pins, bolts or rods) used to secure the protective plate 200 to the side panel 170. The ridge 240 extends along the length of the protective plate 200 and provides reinforcement or rigidity against shear and tensile forces during operation of the vibratory screen 100, as well as protecting the flanges 230. The ridge 240 has a lower face 245 for engaging screen deck 120, as best shown in FIG. 6. In other embodiments, the ridge 240 may be divided into separate ridges with the flanges 230 being arranged between each ridge.

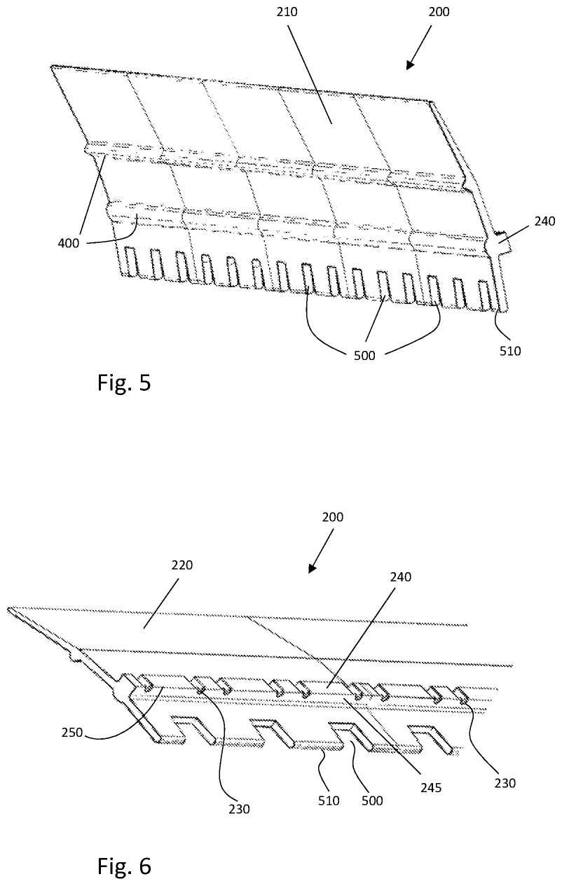

In this embodiment, the outer surface 210 of the protective plate 200 has protrusions for engaging the side panels 170 in the form of ridges 400 extending along the length of the outer surface of the protective plate, as best shown in FIG. 5. The ridges 400 also provide reinforcement or rigidity against shear and tensile forces that occur during operation of the vibratory screen 100. In some situations, the ridges 400 provide some return spring force to ensure engagement with the side panel 170 is not lost during vibratory movement when the vibratory screen 110 is in operation. In this case, the ridges 400 may be formed of a resilient material, such as rubber, foam or the like, or have a resilient member, such as a shock absorber, to tension the protective plate 200 and/or absorb forces applied to the outer surface 210, such as vibrations. The resilient element may be a separate component joined to the protective plate 200 or be integrally formed with the protective plate. The ridges 400 may also assist in securing the protective plate 200 to the side panels 170, by engaging or fitting into a corresponding sleeve or recessed area in the side panels to minimise movement. In other embodiments, the ridges 400 may be replaced with other types of protrusions, such as teeth or studs, as well as having a different configuration. In further embodiments, the ridges 400 may be omitted altogether.

The protective plate 200 also has engagement elements in the form of open slots 500 at its lower edge 510 for allowing water to drain and/or debris to discharge from the bottom of vibratory screen 100 and prevent clogging, as best shown in FIGS. 4 to 6. In other embodiments, the slots 500 may be replaced with holes or channels, or be omitted entirely.

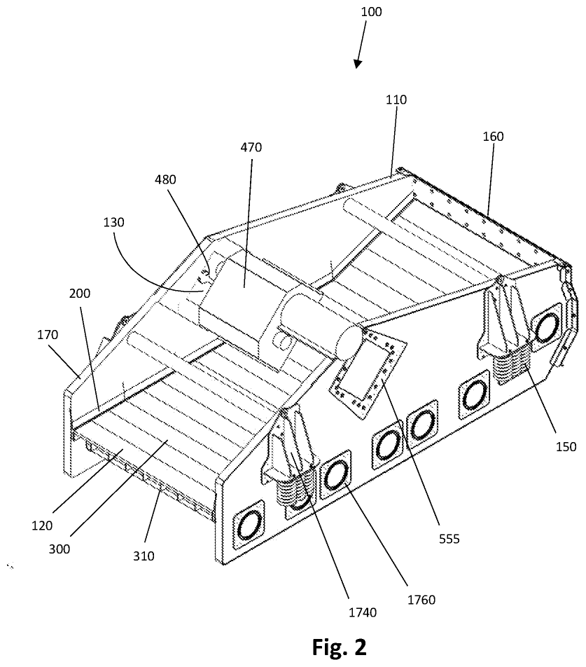

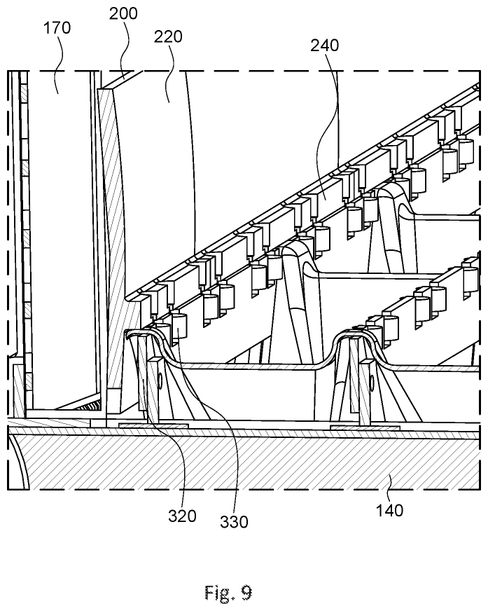

The screen deck 120 comprises a screen surface 300 supported by a plurality of rails 310 and the cross beams 140, as best shown in FIGS. 1 and 2. At least one rail 320 cooperates with the flanges 230 where the screen deck 120 is attached to the side panels 170, as best shown in FIGS. 8 and 9. Also, the lower face 245 of the ridge 240 engages the rail 320 along its length and provides another wear surface. The rail 320 has connecting elements in the form of collars 330 that complement the U-shaped or C-shaped flanges 230 of the protective plate 200. In this embodiment, a bolt, pin or rod is inserted through the collar 330 and against the C-shaped flanges 230 to secure the screen deck 120, protective plate 200 and side panel 170 together.

In operation, ore is fed onto the screen deck 120 and a drive mechanism such as a motor (not shown) causes the drive member assembly 120 reciprocate, move or otherwise shake the frame 110, inducing vibrations in the screen deck 120. Consequently, the ore particles are classified or separated according to their size, with smaller ore particles passing through the screen deck 120 while large ore particles bigger than the openings or apertures in the screen deck 120 remaining on the screen surface 300. During this process, ore particles may strike at the side panels 170. However, the protective plates 200 shield the side panels 170 from these impacts, minimising or preventing damage to the side panels. In addition, the polyurethane composition of the protective plates 200 minimises the damage caused by these impact strikes, as well as being resistant to any corrosive substances in the ore and/or liquid in both dry and wet applications. Accordingly, the protective plates 200 minimise wear and corrosion to the side panels 170 and thus increase the longevity of the vibratory screen 100.

When it is necessary to replace the protective plates 200 in the vibratory screen 100, the bolt, pin or rod is simply removed from the connecting flange 230 and collar 330. The protective plate 200 is then detached from the rail 320, quickly removed from the side panel 170 and replaced. This process is performed quickly and easily, compared to the difficulty in removing a wedged in plate as in the prior art. Thus, labour is saved and downtime for the vibratory screen is reduced.

While the protective plate 200 is described as being composed of polyurethane, in other embodiments, it may be composed of other resilient materials that can provide resilience and resistance to corrosion and/or abrasion, such as carbon, carbon fibre, other plastics including polytetrafluoroethylene (PTFE) or polypropylene (PP), resin, ceramic and the like. Moreover, in other embodiments, the protective plate 200 may comprise an assembly composed of different resilient materials, such as an outer layer of ceramic and an inner layer of polyurethane.

In some embodiments, the ridges 240, 400 need not extend the entire length of the protective plate 200, but may only extend along a portion of the protective plate. The ridges 240, 400 may also be orientated transversely to the length of the protective plate 200, or even extend at an oblique angle, such as diagonally. It will be appreciated that the ridge 240 is configured to match or fit with the screen surface 300 of the screen deck 120, but there is no such requirement for the ridge 400, which may be orientated as desired.

The described C-shaped flanges 230 and collars 330 are a preferred configuration for the connecting elements of the protective plate 200 due to the ease of installation and disassembly. However, other configurations for the connecting elements are possible and may take other forms in other embodiments. For example, the connecting elements may be teeth, lugs or prongs that engage corresponding rings, annular flanges, slots or openings in the rail 320 of the screen deck 120. Alternatively, the protective plate 200 has annular flanges, collars, rings, slots or openings that receive corresponding teeth, lugs or prongs on the rail 320. In another embodiment, the connecting elements may attached directly to the side panel 170 or side rail 320 using a fastener, like a removable bolt. Similarly, the flanges 230 may have other shapes, such as a substantially V-shape, U-shape, hexagonal, oval, triangular, rectangular, octagonal, decagonal, dodecagonal or any other polygonal or part polygonal shape. In other embodiments, the connecting elements or flanges 230 of the protective plate 200 have a shape substantially complementary to corresponding connecting elements of the screen deck 120

It will further be appreciated that features in the preferred embodiment of the invention may be omitted without affecting the operation of the described embodiment. For example, as noted above, the ridges 400 and/or open slots 500 may be omitted from the protective plate 200 without adversely affecting the ability of the protective plate 200 in shielding the side panel 170 from damage or corrosion. Similar omissions or modifications to the features from the described embodiment of the invention can be readily made by one skilled in the art.

It can thus be seen the invention provides a protective plate 200 that is quick and easy to install, while ensuring that the side panels 170 are sufficiently protected from damage and corrosion. In addition, the protective plate 200 is able to be installed without the need to add any additional fixtures to the side panel 170. For example, there is no need to drill through and bolt the protective plate 200 to the side panel 170. This enables the side panels 170 to be designed more freely without have to take into account any such fixtures for the protective plates 200. This results in increased longevity of the vibratory screen and reduces maintenance burdens by saving labour and reduced downtime for replacement of the protective plates. Furthermore, the protective plate of the invention can be readily implemented to existing vibratory screens by adapting the connecting elements, such as directly mounting the protective plate to the side panel or a supporting surface of the screen deck. In all these respects, the invention represents a practical and commercially significant improvement over the prior art. Also, while the invention has been described with reference to specific examples, it will be appreciated by those skilled in the art that the invention may be embodied in many other forms.

1. A protective plate for a vibratory screen having a side panel and a screen deck, comprising:
an outer surface for connecting the protective plate to the side panel; and
an inner surface for protecting the side panel;
wherein the inner surface has one or more connecting elements for connecting the protective plate to the screen deck.

2. The protective plate of claim 1, wherein the connecting elements comprise flanges for cooperating with one or more corresponding connecting elements of the screen deck.

3. The protective plate of claim 2, wherein the flanges each have two arms for engaging the screen deck.

4. The protective plate of claim 1, wherein the connecting elements comprise at least one of a tooth, lug or prong for cooperating with a corresponding connecting element of the screen deck.

5. The protective plate of claim 1, wherein the connecting elements comprise a slot or opening for cooperating with a corresponding connecting element of the screen deck.

6. The protective plate of any one of the preceding claims, wherein the inner surface comprises one or more protrusions for protecting the connecting elements.

7. The protective plate of claim 6, wherein at least one protrusion comprises a ridge extending along the inner surface.

8. The protective plate of claim 7, wherein the ridge extends along the length of the inner surface of the protective plate.

9. The protective plate of claim 6, wherein the protrusions comprise teeth or studs.

10. The protective plate of any one of the preceding claims, wherein the screen deck comprises a screen surface supported by one or more rails and at least one rail cooperates with the connecting elements.

11. The protective plate of claim 10, wherein the at least one rail and the connecting elements of the protective plate are connected by a fastener.

12. The protective plate of claim 10, wherein the at least one rail comprises one or more connecting elements for engaging the connecting elements of the protective plate.

13. The protective plate of claim 12, wherein the connecting elements of the protective plate and the screen deck are connected by a fastener.

14. The protective plate of claim 12, wherein at least one connecting element of the at least one rail comprises an annular flange, collar or ring.

15. The protective plate of claim 14, wherein the connecting element of the protective plate comprises a flange, which is connected to the annular flange, collar or ring by a fastener.

16. The protective plate of any one of the preceding claims, wherein the outer surface comprises one or more protrusions for engaging the side panel.

17. The protective plate of claim 16, at least one protrusion comprises a ridge extending along the outer surface.

18. The protective plate of claim 17, wherein the ridge extends along the length of the outer surface of the protective plate.

19. The protective plate of claim 16, wherein the protrusions comprise teeth or studs.

20. A vibratory screen comprising:
a frame having side panels;
at least one screen deck; and
one or more protective plates according to any one of the preceding claims mounted to at least one side panel.
